(19) United States
(12) Patent Application Publication
(10) Pub. No.: US 2011/0180604 A1
(43) Pub. Date: Jul. 28, 2011

(54) AUTOMATIC INFORMATION TRANSFER BY COLOR ENCODED FIELDS

(75) Inventor: Lawrence Kingsley Murray, Victoria (AU)

(73) Assignee: Universal Biosensors Pty Ltd, Rowville, VIC (AU)

(21) Appl. No.: 13/054,778

(22) PCT Filed: Jul. 17, 2009
(86) PCT No.: PCT/IB2009/006634

§ 371 Date: Jan. 18, 2011

Related U.S. Application Data
(60) Provisional application No. 61/081,610, filed on Jul. 17, 2008.

(51) Int. Cl. G06K 19/06; G06K 7/12

(52) U.S. Cl. 235/469; 235/494

(57) ABSTRACT

Disclosed herein are methods and systems of transferring information from a test strip or an element to a user or an instrumentation using at least one color encoded field. Also disclosed are methods and systems of transferring information from a batch of test strips or entities to a user or an instrumentation, wherein the batch can comprise an extra information carrying entity which can carry extensive information, and the rest entities which can comprise simplified information, such as a link information which can link the entities to the extensive information.

### PRIORITY CLAIM

This application claims priority of U.S. Provisional Application Ser. No. 61/081,610 (entitled “Automatic Information Transfer by Color Encoded Fields”, filed on Jul. 17, 2008), which is incorporated herein by reference.

### BACKGROUND

Different mechanisms are often used to transfer information regarding, such as, test type, calibration data, from an element, such as a single use test strip, to a meter to which the test strip is applicable to perform a medical test. Such mechanisms can also be used in other applications, such as a tag to indicate price, manufacturer, expiration data, etc, of a piece or a batch of merchandise.

### SUMMARY

Some aspects of the disclosure can comprise a test strip, wherein the test strip can comprise information and at least one color encoded field of a shape, a size and a position, wherein the information can be encoded in the at least one color encoded field on the test strip. The at least one color encoded field can comprise information regarding a test type, wherein the test strip is applicable to the test type; manufacturing lot identification information; information for an instrumentation, wherein the test strip is applicable to the instrumentation; information selected from calibration information, manufacturer, expiration date, an intended method of use, and an intended user. The information can be independent of the shape, or the size or the position of the color encoded field. The test strip can comprise at least a first color encoded field of a first shape, a first size and a first position, and a second color encoded field of a second shape, a second size and a second position. The first shape of the first color encoded field can be different from the second shape of the second color encoded field. The information can be independent of the first shape or the second shape. The first size of the first color encoded field can be different from the second size of the second color encoded field. The information can be independent of the first size relative to the second size. The information can be independent of the first position relative to the second position. The at least one color encoded field can be illuminated by a reflective illumination source or a transmissive illumination source to generate a light signal. The generated light signal can be processed to reproduce at least part of the encoded information.

Some aspects of the disclosure can comprise a method of transferring information from a test strip which can comprise: providing a test strip, wherein the information can be encoded in at least one color encoded field on the test strip; illuminating the at least one color encoded field with an illumination source; and generating a light signal. The test strip can comprise at least two color encoded fields. The method can comprise illuminating the at least two color encoded fields in series which can generate a sequence of light signals. The method can comprise illuminating the at least two color encoded fields simultaneously. The illumination source can comprise a reflective illumination source, or a transmissive illumination source. The method can comprise receiving the light signal by a user to reproduce at least part of the encoded information. The method can comprise receiving the light signal with a light detector. The light detector can comprise a photodiode, and/or an optical filter, and/or a transconductance amplifier. The method can comprise transferring the signal to a data acquisition system, wherein the signal can be transformed from the light signal to digital data. The digital data can be processed using a data processing system to reproduce at least part of the encoded information. The data processing system can comprise a computing instrumentation. The information can be transferred to a terminal. The terminal can comprise one selected from a user, a screen, a speaker, a printer, a medical instrumentation, a data storage system, or the like, or any combination thereof.

Some aspects of the disclosure can comprise an element, wherein the element can comprise information and at least one color encoded field of a shape, a size and a position, wherein the information can be encoded in the at least one color encoded field on the element. The at least one color encoded field can comprise at least one piece of information selected from calibration information, manufacturer, manufacturing lot, expiration date, an intended user, price, warranty, potential hazards, intended use and an intended method of use. The information can be independent of the shape, or the size or the position of the color encoded field. The element can comprise at least a first color encoded field of a first shape, a first size and a first position, and a second color encoded field of a second shape, a second size and a second position. The first shape of the first color encoded field can be different from the second shape of the second color encoded field. The information can be independent of the first shape or the second shape. The first size of the first color encoded field can be different from the second size of the second color encoded field. The information can be independent of the first size relative to the second size. The information can be independent of the first position relative to the second position. The at least one color encoded field can be illuminated by a reflective illumination source or a transmissive illumination source to generate a light signal. The generated light signal can be processed to reproduce the information. The at least one color encoded field can be illuminated by a reflective illumination source or a transmissive illumination source to generate a light signal. The generated light signal can be processed to reproduce at least part of the encoded information.

Some aspects of the disclosure can comprise a method of transferring information from an element which can comprise: providing an element, wherein the information can be encoded in at least one color encoded field on the element; illuminating the at least one color encoded field with an illumination source; and generating a light signal. The element can comprise at least two color encoded fields. The method can comprise illuminating the at least two color encoded fields in series which can generate a sequence of light signals. The method can comprise illuminating the at least two color encoded fields simultaneously. The illumination source can comprise a reflective illumination source, or a transmissive illumination source. The method can comprise receiving the light signal by a user to reproduce at least part of the encoded information. The method can comprise receiving the light signal with a light detector. The light detector can comprise a photodiode, and/or an optical filter, and/or a transconductance amplifier. The method can comprise transferring the signal to a data acquisition system, wherein the signal can be transformed from the light signal to digital data. The digital data can be processed using a data processing system to reproduce at least part of the encoded information. The data processing system can comprise a computing instrumentation. The information can be transferred to a terminal. The terminal can comprise one selected from a user, a screen, a speaker, a printer, a medical instrumentation, a data storage system, or the like, or any combination thereof.

Some aspects of the disclosure can comprise a batch of test strips, wherein each of the test strips can comprise information and at least one color encoded field, wherein the information can be encoded in the at least one color encoded field on each of the test strip. The batch of test strips can comprise at least one test strip which can comprise more information than the rest of the batch, wherein each of the rest of the batch can comprise the same information. The batch of test strips can comprise an extra information carrying entity, wherein the extra information carrying entity can comprise information and at least one information carrying field, wherein the information can be encoded in the at least one information carrying field. The information carrying field can, for example, comprise at least one color encoded field, or at least one electronic chip, a barcode, magnetic stripe or other method of encoding machine readable information as is known in the art. The extra information carrying entity can comprise, for example, a container for the batch. The information encoded on the extra information carrying entity can be more than the information encoded on each of the test strips, wherein the information encoded on each of the test strips can be the same.

Various exemplary embodiments are discussed in detail below including a preferred embodiment. While specific implementations are discussed, it should be understood that this is done for illustration purposes only. A person skilled in the relevant art can recognize that the systems, methods and features provided herein can be used without parting from the spirit and scope of the invention. Furthermore, any and all references cited herein shall be incorporated herein by reference.

### BRIEF DESCRIPTION OF THE DRAWINGS

The foregoing and other features and advantages of the invention will be apparent from the following, more particular description of exemplary embodiments of the invention, as illustrated in the accompanying drawings. A preferred exemplary embodiment is discussed below in the detailed description of the following drawings:

FIG. 1 is a functional block diagram of certain embodiments showing data transfer using a reflective light source;

FIG. 2 is a functional block diagram of certain embodiments showing data transfer using a transmissive light source;

FIG. 3 is a functional block diagram of certain embodiments showing a red, green, blue (RGB) color model implementation;

FIG. 4 shows an exemplary embodiment of a computer system that can be used in association with, in connection with, and/or in place of certain components in accordance with the present embodiments.

### DETAILED DESCRIPTION

Various exemplary embodiments are discussed in detail below including a preferred embodiment. While specific implementations are discussed, it should be understood that this is done for illustration purposes only. A person skilled in the relevant art can recognize that the systems, methods and features provided herein can be used without parting from the spirit and scope of the invention. Furthermore, any and all references cited herein shall be incorporated herein by reference.

There can often be a need to transfer information such as batch calibration or type data between a single use element and the measuring instrumentation. For example, many meters used for medical testing applications can use disposable test strips for the sampling, processing and testing of bodily fluids. The test results of such instrumentation can be used in the diagnosis, detection and/or control of patient infection. Within the meter instrumentation there can be a need to positively identify the type of a test strip being inserted and a need to input calibration parameter information related to the batch manufacture of the test strips. This can be done in a number of ways, such as, for example, by the user entering a code by pressing buttons on the meter, via a magnetic swipe card, via a calibration strip with an electrical resistance that the meter can read, an electronic memory chip inserted into the meter and/or via a barcode printed onto the strip, and the like.

In one or more embodiments, there can be a number of different ways that information regarding, such as, for example, calibration, type, or the like, or the combination thereof, can be input from a single use element into the measuring instrumentation. These can comprise, for example, direct user input on a keypad, barcode scanning and/or encoded electrical contact techniques, and the like.

The techniques described herein can use color and/or light to provide an electrical contact free approach to transferring information from, for example, a single use element to the measuring instrumentation, among others. The information can comprise, such as, for example, batch information, calibration information, type information, expiration date, or other parametric data, or any combination thereof.

The techniques of transferring information described herein can be applied to a test strip. The test strip can be, for example, a single use or disposable test strip. The test strip can be reusable or non-disposable. The information can be encoded in at least one field on the test strip, such as, for example, a color encoded field. The information encoded in the at least one field can comprise the information regarding, such as, for example, the test type or instrumentation to which the test strip can be applicable, manufacturer, manufacturing lot identification, calibration, batch, expiration date, an intended user, an intended method of use, or other parametric data, or any combination thereof.

The techniques of transferring information described herein can be applied to an element. The element can be for a single use, or disposable. The test strip can be reusable, or non-disposable. The information can be encoded in at least one field on the element, such as, for example, a color encoded field. The information encoded in the at least one field can comprise the information regarding, such as, for example, the instrumentation to which the element can be applicable, manufacturer, manufacturing lot identification, calibration, batch, expiration date, an intended user, an intended method of use, an intended method of handling and/or storage, and/or disposal, warranty, price, potential hazard, or the like, or any combination thereof. The element can comprise a test strip, or a single piece of merchandise, or a batch thereof, or a container for the batch, or the like.

Merely for the purpose of convenience, the following embodiments can be described in terms of an element on which the information is encoded and/or from which information is transferred. However, it is understood that this is for the purpose of illustration only, and is not intended to limit the scope of the disclosure. It should be understood the techniques described herein can be applicable to any element on which information is encoded and/or from which information is transferred.

The element can comprise at least one surface on which information can be encoded and/or to which information can be transferred, for example, a user or an instrumentation. If the element includes a plurality of color encoded fields, the fields can be on the same surface or different surfaces of the element.

Information can be encoded in at least one color encoded field on the element. The color can comprise any one with a wavelength within the visible light ranges, or invisible light ranges, e.g. in the infrared ranges, or ultraviolet ranges. The color encoded field can comprise a shape, a size and/or a position on the element. The shape can comprise one such as, for example, square, rectangular, circular, oval, triangular, rhomboid, trapezoidal, hexagon, star, cross, octagon, or the like, or any combination thereof. As used herein, the size of the color encoded field can refer to its one-dimensional size, such as the length(s) of the edge(s), the diameter, the length(s) along its major axis and/or minor axis, or the like; and/or two-dimensional size, such as the area it covers. The position of the color encoded field can refer to its position on the surface of the element on which it is encoded. For example, the position can refer to the distance the center and/or the edge(s) of the color encoded field from the center and/or the edge(s) of the surface. The content of the information can be independent of the shape, the size or the position of the color encoded field. Merely by way of example, information regarding a test type can be encoded in a color encoded field on a test strip, wherein the color can comprise a wavelength within the human visible light range. Such a color encoded field can allow a non-color vision impaired user with or without reading abilities to visually check the test type prior to inserting the test strip into an instrumentation to which the test strip is applicable for the test. The shape, and/or the size and/or the position of the color encoded field can comprise part of the encoded information. Merely by way of example, the color encoded field can be positioned non-symmetrically in terms of at least one axis (e.g., the longitudinal axis) of the surface of the element, and its position can indicate the orientation of the element, for example, its proximal end vs. distal end, and/or its right end vs. left end, and/or its upper surface vs. bottom surface, or the like, or any combination thereof.

Information can be encoded in more than one color encoded field on the element. Each color encoded field can comprise a shape, and/or a size and/or a position on the element. An element can comprise a plurality of color encoded fields. For example, the element can comprise at least one, or at least two, or at least three, or at least four, or at least five, or more color encoded fields. The color encoded fields can comprise the same shape or different shapes. For example, all the color encoded fields can comprise a bar shape; or some of them can comprise a bar shape, and the others can comprise a circular shape; or each encoded field can comprise a unique shape. Each color encoded field can comprise the same size. At least some of the color encoded fields can comprise different sizes than the others. At least some of the plurality of color encoded fields can comprise different positions than the others. Not all the plurality of color encoded fields overlap completely. As used herein, “overlap completely” can refer to that at least two color encoded fields on the same surface of an element comprise the same shape, and the same size, and the same position. In some embodiments, the content of the information can be independent of the shapes, the relative sizes or the relative positions of some or all the color encoded fields on the element. In other embodiments, the shapes, and/or the relative sizes and/or the relative positions of some or all the color encoded fields can comprise part of the encoded information. Merely by way of example, the information can be encoded in a first color encoded field and a second color encoded field. The first color encoded field can comprise a first shape, a first size and a first position. The second color encoded field can comprise a second shape, a second size and a second position. The information can be independent of the first shape and the second shape, which can be the same or different. The information can be independent of the first size relative to the second size. The information can be independent of the first position relative to the second position. The first shape and the second shape, and/or the first size relative to the second size, and/or the first position relative to the second position can comprise part of the encoded information. For example, the first color encoded field of the first shape, the first size and first position can comprise information regarding the test type of the element, e.g., a test strip; and the second color encoded field of the second shape, the second size and second position can comprise information regarding the expiration date of the element. The encoded information can be independent of the first shape, the first size or the first position relative to the second shape, the second size or the second position. As another example, if the information regarding the test type and expiration date is encoded in the first color encoded field with a circular shape and the second color encoded field with a triangular shape such that, for example, the circular color encoded field comprises information regarding the test type, and the triangular color encoded field comprises information regarding the expiration date, then the shapes of the two color encoded fields can comprise part of the encoded information. Similarly, the sizes and/or the positions of the two color encoded fields can comprise part of the encoded information. Information can be encoded in more than two color encoded fields on an element, dependent on or independent of the shape, and/or the size and/or position of each color encoded field relative to the shape, and/or the size and/or position of the others, in a manner similar to what is described above.

In some embodiments, the color encoded fields can be read by a user or an instrument at any order or simultaneously, without changing the information reproduced based on the color encoded fields by the user or the instrumentation. In other embodiments, at least some of the color encoded fields can be read in a specified order to reproduce the encoded information properly. Merely by way of example, the color encoded fields read in the right order by an instrumentation can indicate that the element, for example, a test strip, is inserted into the instrumentation in the right direction.

If the element comprises a batch of entities, each entity can comprise information encoded in at least one color encoded field. The entities can comprise, such as, for example, multiple pieces of the same merchandise, multiple test strips of the same type, and an extra information carrying entity, or the like, or any combination thereof. The extra information carrying entity can comprise a container for the batch of entities. In some embodiments, each entity can comprise the same information encoded in the same color encoded field(s). In other embodiments, one entity can be the extra information carrying entity and can comprise an extensive set of information for the batch, and the rest of the entities can comprise less information, but enough to link them to the extensive set of information. The extra information carrying entity can comprise a more complicated information carrying field. The extra information carrying entity can comprise a more complicated and/or more expansive information transferring mechanism, such as, for example, a more complicated color encoded field, or an electronic chip, a barcode, magnetic stripe, or the like, while the remaining entities can comprise a simplified color encoded field or fields. The extra carrying entity can comprise the container. Merely by way of example, an element can comprise a batch of test strips for a type of test and a container for these test strips. The container can be the extra information carrying entity and can comprise more extensive information about the test strips. The container can comprise information regarding, such as, for example, batch number, expiration date, calibration, type, or the like, or any combination thereof, while the test strip can comprise link information which can link the test strip to the extensive information encoded on the extra information carrying entity. The link information can comprise, such as, for example, the batch number. In some embodiments, a user can transfer the information from the container to a meter once, wherein the meter can store the information onto a data storage device, e.g. a memory. Subsequently, each time a test strip of the same batch is inserted into the meter, the meter can read the batch number or other link information and search its data storage device, e.g., its memory, and link the test strip to the corresponding extra information with the matching batch number or other link information. If no extra information is found using the link information, the meter can prompt the user to input the extra information. In this manner, the extra information carrying entity can comprise the extensive information encoded in a more complicated and/or more expensive information carrying mechanism, e.g., at least one color encoded field, or an electronic chip, a barcode, magnetic stripe or other method of encoding machine readable information as is known in the art, while the other entities can comprise simplified link information encoded in a simpler color encoded field or fields which can link the entities to the extensive information.

One or more color fields can be applied during the final stages of the production process to an exemplary single use element by printing and/or laminating techniques. The material for a color encoded field can comprise inks, substrates printed with colored inks, tapes or other shaped material where the bulk material is the color of choice or tapes or other shaped materials comprising filling materials which impart the desired color to the material. In some embodiments, the material can have a fixed color in the normal ambient environment the element is exposed to, such as, for example, temperature, humidity, light, pH, shelf time, or the like, or any combination thereof. In some embodiments, the material can change its color with ambient environment parameters, such as, for example, temperature, humidity, light exposure, pH, shelf time, or the like, or any combination thereof. The change of its color can indicate a change in a property of the element. Merely by way of example, if the color encoded field comprises a material which can change its color when the material and the element on which the material is printed are exposed to an excessive humidity, and/or after a certain amount of shelf time, the change of the color can indicate (1) that the element is no longer effective and/or accurate for its intended use; and/or (2) that a different parameter can be applied to the element. The parameter can comprise a calibration parameter, a price, a storage or disposal method, or the like, or any combination thereof.

Alternatively, one or more of the color encoded fields can result from the intrinsic color of an exemplary single use element's construction materials. The color fields can be read in sequence and/or simultaneously as the single use element can be inserted into the instrument. The color encoded fields can be interpreted by the instrument to provide any type of information, such as the type and/or batch calibration parameters.

In exemplary embodiments, the color encoded fields of an element, e.g., a test strip, can be illuminated by a light source rich in the wavelengths of light relevant to the color encoded fields to be read. As used herein, “relevant” can mean that the wavelengths of the light source are similar to that/those of the color/colors in the color encoded field(s) to be read. The color encoded fields can be read using color detection electronic circuits, the outputs of which can be interpreted by a software application to yield the data to be transferred to the instrumentation. The light source and/or the software can be part of the instrumentation which the element can be inserted into or used with.

In exemplary embodiments, the light source and/or associated light detector can be arranged to be either reflective for a non-transparent element or transmissive for a transparent element.

In exemplary embodiments, color calibration of the detector and a method of error checking can be encoded in the color encoded field(s) on the element with the data to be transferred to an instrumentation.

In exemplary embodiments, color encoding within the human visible light range can allow a non-color vision impaired user with or without reading abilities to visually check the element type prior to inserting the element into, or using the element with an instrumentation.

In exemplary embodiments, the color encoded field(s) can be used to transfer information to a combination of a user and at least one instrumentation. Merely by way of example, information can be encoded in one color encoded field on a test strip. The color encoded field can comprise a color within the human visible light range. The encoded information can comprise test type and calibration information. A non-color vision impaired user with or without reading abilities to visually check the test type encoded in the color encoded field by, such as, for example, its color, or its shape, or its size, or its position, or the combination thereof, and a meter which is compatible with the test strip can reproduce the calibration information encoded in the color encoded field by, such as, for example, its color, or its shape, or its size, or its position, or the combination thereof. An element can comprise a plurality of color encoded fields, some of which can be used to transfer information to a user, and some of which can be used to transfer information to an instrumentation.

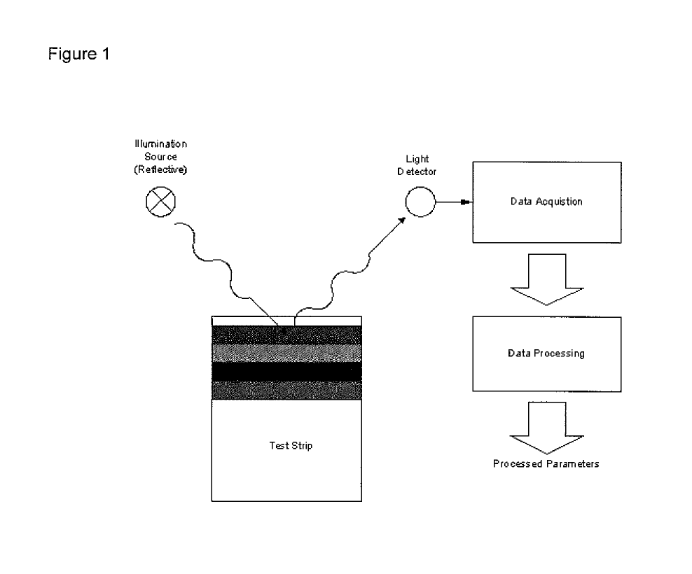

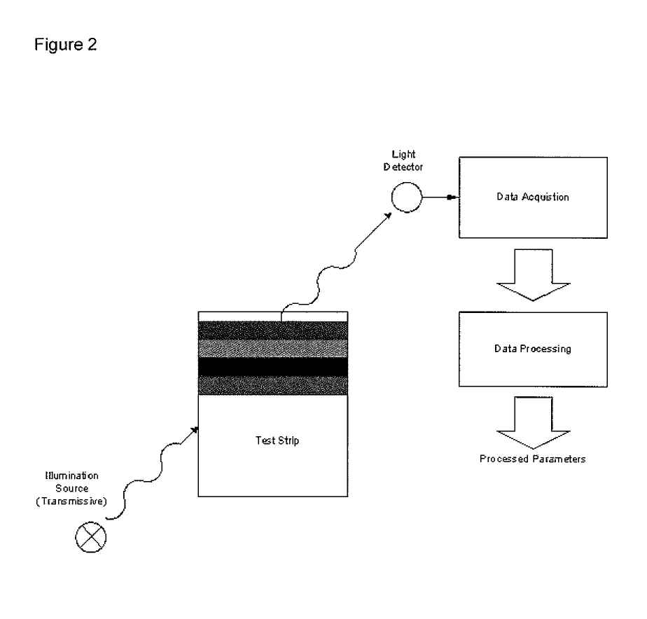

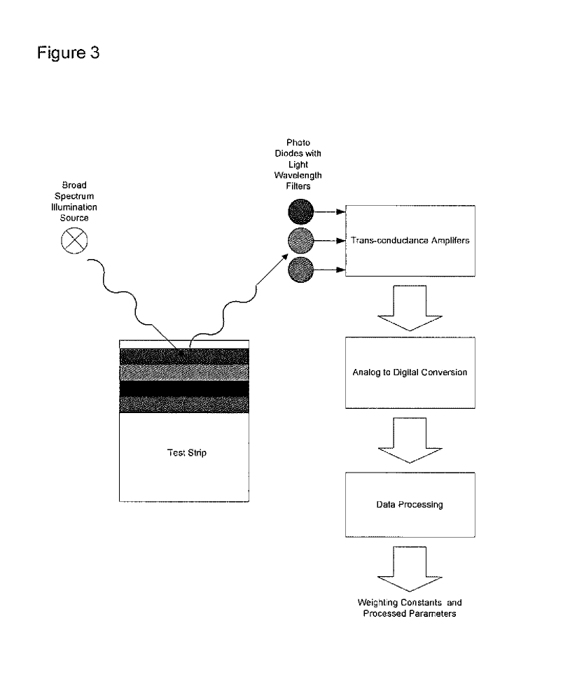

FIGS. 1, 2 and 3 can be described as follows. FIG. 1 illustrates an exemplary data transfer using a reflective light source. FIG. 2 illustrates an exemplary data transfer using a transmissive light source. FIG. 3 illustrates an exemplary implementation using an exemplary Red/Green/Blue (RGB) additive color model as described herein. The exemplary embodiments illustrated in FIGS. 1-3 comprise four color bars. Merely by way of example, from the top to the bottom, the first color bar to the fourth color bar can comprise red, green, blue and pink. In the system illustrated in FIG. 3, the photodiodes can comprise light wavelength filters for red, green and blue. The information encoded in the four color bars can be independent of or dependent on the positions of at least some of the four color bars. As described herein, the position of a color bar can comprise that relative to the edges of the element, and/or that relative to the other color bars on the element. Information can be encoded in the color bars such that the light source can strike onto at least some of the four color bars simultaneously in order to transfer the encoded information properly. Information can be encoded in the color bars such that the light source can strike onto the four color bars in series, for example, one after another, in order to transfer at least part of the encoded information properly. Information can be encoded in the color bars such that the light source can strike onto some of the color bars simultaneously, and the other color bars in series, in order to transfer at least part of the encoded information properly. Merely by way of example, the light source can strike onto the first two color bars from the top edge of the element simultaneously, then strike onto the third and the fourth color bars, in order to transfer at least part of the encoded information properly.

As illustrated in exemplary FIG. 3, a medical test strip can be illuminated with a light source containing wavelengths of light with components of a number of colors (for example, all 3 primary colors) to be detected. The detection photodiodes can incorporate optical filters with enough precision to differentiate each of the primary colors. The photodiode output currents can be converted to voltages using trans-conductance amplifiers. The converted voltages can be converted to digital form for processing by the instrument's software. Integrated circuit devices can be available to implement filtering, photodiodes, trans-conductance amplification and analog to digital conversion (e.g., TCS3414CS, Texas Advanced Optoelectronics Solutions or ADJD-S313-QR999, Avago Technologies).

A method of transferring information from an element, such as, for example, a test strip, can comprise, providing en element, wherein the information can be encoded in at least one color encoded field; illuminating the at least one color encoded field with an illumination source, and generating a light signal. In some embodiments, the element can comprise at least two color encoded fields. The method can comprise illuminating the at least two color encoded fields in series, which can generate a sequence of light signals. As used herein, “sequence” can indicate that the order in which the light signal is received and/or interpreted by the following system(s) can comprise part of the information or can determine whether the information can be reproduced properly. The method can comprise illuminating the at least two color encoded fields simultaneously. As used herein, “simultaneously” can indicate that the order in which the light signal is received and/or interpreted by the following system(s) does not change the information reproduced by the following system(s). The following system(s) can comprise, such as, for example, a light detector, a data acquisition system, a data processing system, or the like.

The light signal generated by the light source striking onto the color encoded field(s) as exemplified in FIGS. 1-3 can be received by a light detector. The light detector can comprise an eye of a user. In such cases, the light signal can be transferred to the brain of the user to reproduce at least part of the encoded information. The correlation between the light signal and the at least part of the encoded information can be taught to the user by an oral or written instruction.

The light detector can comprise a photodiode and/or an optical filter. The optical filter can selectively transmit light having certain properties, such as, for example, a particular range of wavelengths, while blocking the remainder light. The photodiode output currents can be converted to voltages using transconductance amplifiers. The converted voltages can then be converted to digital form, and then be further processed by a data processing system. A data processing system can comprise a computing instrumentation. The computing instrumentation can comprise, such as, for example, a computer, or the like. The processed data can be transferred to a terminal. The terminal can comprise, such as, for example, a user, a screen, a speaker, a printer, a medical instrumentation, a data storage system, or the like, or any combination thereof.

In addition to creating one more new system to implement the current embodiments, existing systems can be modified according to the current embodiments. For example, integrated circuit devices can be available to implement filtering, photodiodes, transconductance amplification and/or analog to digital conversion, through modification (for example, via TCS3414CS, Texas Advanced Optoelectronics Solutions or ADJD-S3 13-QR999, by Avago Technologies).

To improve the color detectability of the light signal received by the light detector, the viewing window of the light detector can be less than the minimum width of a color encoded field. Constraining the window further than the minimum width of the color encoded field can have the effect of allowing a reading period where the light detected by the light detector is substantially of a single color, decreasing the possibility of interference to the detection from light of different colors.

To improve the detection performance the illumination source can be matched to the light wavelength and intensity sensitivity of the light detector, The manufactures of the light detectors can make recommendations regarding an optimal illumination source used with their light detector products.

Merely by way of example, when an element, e.g., a test strip, is inserted into the meter, the color encoded field(s) on the test strip can be used to determine, for example, the color weighting for each primary color. The weights can compensate for variation in the spectral components of the light source and/or for changes in the color saturation of a test strip, among other items. The information regarding, such as, for example, the calibration and/or strip type can be reproduced from the light signal, and be transferred to the meter. Error checking can be incorporated into the numerical values of the parameters derived from the information transferred to the meter to assist in a determination as to whether or not the information was read correctly.

Numerical encoding of the light signal during the conversion from the light signal to a digital signal can use either absolute values assigned to each color encoded field or the normalized difference between colors across the field transition boundaries.

In one embodiment of the current invention more than one color encoded field is included. In this embodiment is it desirable that separate fields encoded with the same color are not immediately adjacent, as this can increase the difficulty in distinguishing the two fields as separate. In order to ameliorate this difficulty encoding rules can be used which prevented fields of the same color being placed immediately adjacent to one another, or alternatively, a section of a color different to that of the fields of the same color can be placed between them. For example a base calibration color, e.g., white or black, can be used to delineate the edge of a color encoded field such that two fields of the same color can be readily distinguished as separate. A base calibration color can be used in a different way to delineate identical immediately adjacent colors that can otherwise be defined as being the same. For example, when the base calibration color is read prior to the expected end of the read process the base calibration color can be interpreted as a second field of the same color as the immediately proceeding field.

In some embodiments, color encoded fields can be read in a serial fashion. The information reading process can be independent of the speed of serial reading within predetermined design limits. Merely by way of example, the predetermined design limits can depend on considerations, such as, the physical limits regarding the speed of a meter to illuminate the color encoded fields, to transfer the light signal, to process the light signal to reproduce at least part of the encoded information. It can be possible to create a speed of serial reading outside of the desired range, for example, by a user inserting an element, e.g., a test strip, into an instrumentation, e.g., a meter, too quickly or too slowly. It can be therefore desirable to have a method by which the speed of reading can be monitored during the reading process and judged for suitability. A suitable method can comprise monitoring the speed at which the serial color transitions occur and comparing this against an acceptable speed range to help ensure that the actual rate of reading is compatible with the predetermined limits.

In embodiments where multiple color encoded fields are used The number of color encoded fields read can be used as one check of whether an accurate read has occurred Numerically more or less fields than expected can be interpreted by the meter as an reading error.

### EXEMPLARY PROCESSING AND COMMUNICATIONS EMBODIMENTS

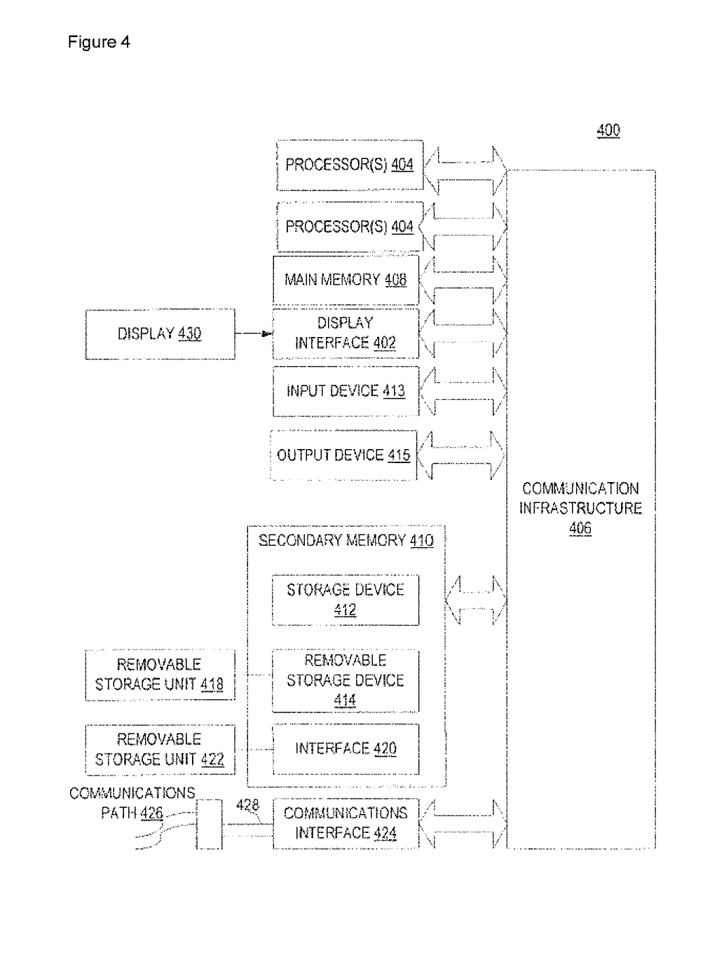

FIG. 4 depicts an exemplary embodiment of a computer system 400 that can be used in association with, in connection with, and/or in place of, but not limited to, any components, systems and/or processes for implementing the present embodiments.

As described above, a light detector can receive a light signal generated by a light source striking on at least one color encoded field on an element. The light signal can be transferred to a data acquisition system. The data acquisition system can convert the light signal to another form, such as, for example, digital data. The digital data can be processed by a data processing system. The processed data can be transferred to a terminal. The terminal can comprise, such as, for example, a user, a screen, a speaker, a printer, a medical instrumentation, a data storage system, or the like, or any combination thereof.

For example, the present embodiments (or any part(s) or function(s) thereof) can be implemented using hardware, software, firmware, or a combination thereof and can be implemented in one or more computer systems or other processing systems. In fact, in one exemplary embodiment, the invention can be directed toward one or more computer systems capable of carrying out the functionality described herein. An example of a computer system 400 is shown in FIG. 4, depicting an exemplary embodiment of a block diagram of an exemplary computer system useful for implementing the present invention. Specifically, FIG. 4 illustrates an example computer 400, which in an exemplary embodiment can be, e.g., (but not limited to) a personal computer (PC) system running an operating system such as, e.g., (but not limited to) WINDOWS® MOBILE™ for POCKET PC, or MICROSOFT® WINDOWS® NT/98/2000/XP/CE, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX® HPUX® IBM AIX®, and SCO/UNIX®, etc. However, the invention are not limited to these platforms. Instead, the invention can be implemented on any appropriate computer system running any appropriate operating system. In one exemplary embodiment, the present invention can be implemented on a computer system operating as discussed herein. An exemplary computer system, computer 400 is shown in FIG. 4. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., can also be implemented using a computer such as that shown in FIG. 4.

The computer system 400 can comprise one or more processors, such as, e.g., but not limited to, processor(s) 404. The processor(s) 404 can be connected to a communication infrastructure 406 (e.g., but not limited to, a communications bus, cross-over bar, or network, etc.). Various exemplary software embodiments can be described in terms of this exemplary computer system. After reading this description, it will become apparent to a person skilled in the relevant art(s) how to implement the invention using other computer systems and/or architectures.

Computer system 400 can comprise a display interface 402 that can forward, e.g., but not limited to, graphics, text, and other data, etc., from the communication infrastructure 406 (or from a frame buffer, etc., not shown) for display on the display unit 430.

The computer system 400 can comprise, e.g., but are not limited to, a main memory 408, random access memory (RAM), and a secondary memory 410, etc. The secondary memory 410 can comprise, for example, (but not limited to) a hard disk drive 412 and/or a removable storage drive 414, representing a floppy diskette drive, a magnetic tape drive, an optical disk drive, a compact disk drive CD-ROM, etc. The removable storage drive 414 can, e.g., but not limited to, read from and/or write to a removable storage unit 418 in a well known manner. Removable storage unit 418, also called a program storage device or a computer program product, can represent, e.g., but not limited to, a floppy disk, magnetic tape, optical disk, compact disk, etc. which can be read from and written to by removable storage drive 414. The removable storage unit 418 can comprise a computer usable storage medium having stored therein computer software and/or data.

In alternative exemplary embodiments, secondary memory 410 can comprise other similar devices for allowing computer programs or other instructions to be loaded into computer system 400. Such devices can comprise, for example, a removable storage unit 422 and an interface 420. Examples of such can comprise a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 422 and interfaces 420, which can allow software and data to be transferred from the removable storage unit 422 to computer system 400.

Computer 400 can comprise all input device such as, e.g., (but not limited to) a mouse or other pointing device such as a digitizer, and a keyboard or other data entry device (none of which are labeled).

Computer 400 can also comprise output devices, such as, e.g., (but not limited to) display 430, and display interface 402. Computer 400 can comprise input/output (I/O) devices such as, e.g., (but not limited to) communications interface 424, cable 428 and communications path 426, etc. These devices can comprise, e.g., but not limited to, a network interface card, and modems (neither are labeled). Communications interface 424 can allow software and data to be transferred between computer system 400 and external devices. Examples of communications interface 424 can comprise, e.g., but are not limited to, a modem, a network interface (such as, e.g., an Ethernet card), a communications port, a Personal Computer Memory Card International Association (PCMCIA) slot and card, etc. Software and data transferred via communications interface 424 can be in the form of signals 428 which can comprise electronic, electromagnetic, optical or other signals capable of being received by communications interface 424. These signals 428 can be provided to communications interface 424 via, e.g., but not limited to, a communications path 426 (e.g., but not limited to, a channel). This channel 426 can carry signals 428, which can comprise, e.g., but not limited to, propagated signals, and can be implemented using, e.g., but not limited to, wire or cable, fiber optics, a telephone line, a cellular link, a radio frequency (RF) link and other communications channels, etc.

In this document, the terms “computer program medium” and “computer readable medium” can be used to generally refer to media such as, e.g., but not limited to, removable storage drive 414, a hard disk installed in hard disk drive 412, and signals 428, etc. These computer program products can provide software to computer system 400. The invention can be directed to such computer program products.

References to “one embodiment,” “an embodiment,” “example embodiment,” “various embodiments,” etc., can indicate that the embodiment(s) of the invention so described can comprise a particular feature, structure, or characteristic, but not every embodiment necessarily comprises the particular feature, structure, or characteristic. Further, repeated use of the phrase “in one embodiment,” or “in an exemplary embodiment,” do not necessarily refer to the same embodiment, although they can.

In the following description and claims, the terms “coupled” and “connected,” along with their derivatives, can be used. It should be understood that these terms are not intended as synonyms for each other. Rather, in particular embodiments, “connected” can be used to indicate that two or more elements are in direct physical or electrical contact with each other. “Coupled” can mean that two or more elements are in direct physical or electrical contact. However, “coupled” can also mean that two or more elements are not in direct contact with each other, but yet still co-operate or interact with each other.

An algorithm is here, and generally, considered to be a self-consistent sequence of acts or operations leading to a desired result. These can comprise physical manipulations of physical quantities. Usually, though not necessarily, these quantities can take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” can refer to any device or portion of a device that processes electronic data from registers and/or memory to transform that electronic data into other electronic data that can be stored in registers and/or memory. A “computing platform” can comprise one or more processors.

Embodiments of the present invention can comprise apparatuses for performing the operations herein. An apparatus can be specially constructed for the desired purposes, or it can comprise a general purpose device selectively activated or reconfigured by a program stored in the device.

Embodiments of the invention can be implemented in one or a combination of hardware, firmware, and software. Embodiments of the invention can also be implemented as instructions stored on a machine-readable medium, which can be read and executed by a computing platform to perform the operations described herein. A machine-readable medium can comprise any mechanism for storing or transmitting information in a form readable by a machine (e.g., a computer). For example, a machine-readable medium can comprise read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), can comprise object oriented computer programs, and can be stored in main memory 408 and/or the secondary memory 410 and/or removable storage units 414, also called computer program products. Such computer programs, when executed, can enable the computer system 400 to perform the features of the present invention as discussed herein. In particular, the computer programs, when executed, can enable the processor 404 to provide a method to resolve conflicts during data synchronization according to an exemplary embodiment of the present invention. Accordingly, such computer programs can represent controllers of the computer system 400.

In another exemplary embodiment, the invention can be directed to a computer program product comprising a computer readable medium having control logic (computer software) stored therein. The control logic, when executed by the processor 404, can cause the processor 404 to perform the functions of the invention as described herein. In another exemplary embodiment where the invention can be implemented using software, the software can be stored in a computer program product and loaded into computer system 400 using, e.g., but not limited to, removable storage drive 414, hard drive 412 or communications interface 424, etc. The control logic (software), when executed by the processor 404, can cause the processor 404 to perform the functions of the invention as described herein. The computer software can run as a standalone software application program running atop an operating system, or can be integrated into the operating system.

In yet another embodiment, the invention can be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention can be implemented primarily in firmware.

In yet another exemplary embodiment, the invention can be implemented using a combination of any of; e.g., but not limited to, hardware, firmware; and software, etc.

Exemplary embodiments of the invention can also be implemented as instructions stored on a machine-readable medium, which can be read and executed by a computing platform to perform the operations described herein. A machine-readable medium can comprise any mechanism for storing or transmitting information in a form readable by a machine (e.g., a computer). For example, a machine-readable medium can comprise read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Some exemplary embodiments of the present invention make reference to wired, or wireless networks. Wired networks can comprise any of a wide variety of well known means for coupling voice and data communications devices together. Various exemplary wireless network technologies that can be used to implement the embodiments of the present invention can be discussed briefly. The examples are non-limited. Exemplary wireless network types can comprise, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB), etc. Bluetooth is an emerging wireless technology promising to unify several wireless technologies for use in low power radio frequency (RF) networks. IrDA is a standard method for devices to communicate using infrared light pulses, as promulgated by the Infrared Data Association from which the standard gets its name. Since IrDA devices can use infrared light, they can depend on being in line of sight with each other.

The exemplary embodiments of the present invention can make reference to WLANs. Examples of a WLAN can comprise a shared wireless access protocol (SWAP) developed by Home radio frequency (HomeRP), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN can comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11a, b, d and g, (including, e.g., but not limited to IEEE 802.11g-2003, etc.), etc.

### EXAMPLE

### Example 1

A test strip for a blood test comprises one color encoded field on a surface. The color encoded field comprises a yellow color which indicates that the test strip is applicable to a meter to perform a blood test. A non-color vision impaired user without reading ability knows that he or she is using the right test strip with the meter when he or she sees the yellow field on the test strip.

### Example 2

A test strip comprising one color encoded field on one surface is applicable to a meter to perform a blood test. The meter comprises a speaker, an illumination source which can illuminate the color encoded fields on the test strip to generate a light signal, a light detector which receives the light signal, a data processing system which converts the light signal to digital data, and interpret the digital data to reproduce the encoded information. The color encoded field comprises a yellow color which indicates that the test strip is applicable to a meter to perform a blood test. The color encoded field is readable by the meter to reproduce calibration parameters. A non-color vision impaired user without reading ability knows that he or she is using the right test strip with the meter when he or she sees the yellow field on the test strip. After the user inserts the test strip to the meter, the meter can read the yellow field and reproduce the calibration information encoded therein. An error message or the testing result can be reported to the user by an audible signal via the speaker.

### Example 3

A test strip comprising two color encoded fields is applicable to a meter to perform a urine test. The meter comprises a screen, an illumination source which can illuminate the color encoded fields on the test strip to generate a light signal, a light detector which receives the light signal, a data processing system which converts the light signal to digital data, and interpret the digital data to reproduce the encoded information. The test strip comprises information regarding expiration date and test type encoded in the two color encoded fields. Both of the color encoded fields are on the same surface of the test strip, and are readable by the meter. The expiration date is encoded in one of the two color encoded fields which comprises a red color and a triangular shape. The test type information is encoded in the other color encoded field which comprises a green color and a circular shape. When a user inserts the test strip to the meter, the meter recognizes the color and the shape of each color encoded field and reproduces the encoded information regarding the expiration date and the test type. If the test date is subsequent to the expiration date, the meter sends an error code to the screen and optionally, an audible signal, such as a beep. Similarly, if the test type information does not match that acceptable by the meter, the meter sends out an error code to the screen and optionally an audible signal. The user can identify the source of the error by looking up the error code in the meter's manual.

### Example 4

A test strip with information encoded in five color bars is applicable to a meter to perform a blood test. The blood test is to measure the concentration of an inflammation cytokine related to a cardiovascular disease. The concentration of the inflammation cytokine can be converted to a risk factor for the cardiovascular disease through an algorithm. The meter comprises a screen, an illumination source which can illuminate the color encoded fields on the test strip to generate a light signal, a light detector which receives the light signal, a data processing system which converts the light signal to digital data, and interpret the digital data to reproduce the encoded information. The test strip comprises a rectangular shape with a longitudinal axis, wherein the longitudinal axis is parallel to the long edges of the test strip. The test strip comprises a proximal edge and a distal edge along its longitudinal axis. The five color bars are positioned next to each other. The top color bar is close to the proximal edge of the test strip, while the bottom color bar is close to the distal edge of the test strip. The five color bars comprise the same size, and comprise red, yellow, black, blue, purple from the top to bottom. The information encoded in the five color bars comprises calibration parameters and algorithm which correlates between the result from blood test and the risk factor for the cardiovascular disease. When a user inserts the test strip into the meter, the illumination source within the meter illuminates the five color bars in series which generates a sequence of light signals. The light detector receives the sequence of light signals and transfers them to the data processing system. The data processing system converts the sequence of light signals to digital data and reproduces the encoded information.

### Example 5

A container contains a batch of test strips of the same type. The container comprises an electronic chip which comprises information regarding the batch lot number, the expiration date and the calibration parameters. Each test strip comprises a color encoded field. The color encoded field comprises information regarding just the batch lot number. The test strips are applicable to a meter to perform a blood test. The meter comprises a screen, an illumination source which can illuminate the color encoded fields on the test strip to generate a light signal, a light detector which receives the light signal, a data processing system which converts the light signal to digital data, and interprets the digital data to reproduce the encoded information. The meter also comprises a reader and a memory, wherein the reader can read the electronic chip to reproduce the information stored in the electronic chip, and wherein the memory stores the information the reader obtains from the electronic chip. The first time a user uses a test strip from the batch, the user allows the reader of the meter to read the electronic chip in the container. In this way, the extensive information regarding the batch of test strips is transferred to and stored in the meter. After that, each time the user uses a test strip from that batch, the meter recognizes the batch lot number encoded in the color encoded field on the test strip, and links the test strip to the extensive information regarding that batch.

While various embodiments of the invention disclosed herein have been described above. It should be understood that they have been presented by way of example only, and not limitation. Thus, the breadth and scope of the present invention should not be limited by any of the above-described exemplary embodiments, but should instead be defined only in accordance with the following claims and their equivalents.

The skilled artisan will recognize the applicability of various configurations and features from different embodiments described herein. Similarly, the various configurations and features discussed above, as well as other known equivalents for each configuration or feature, can be mixed and matched by one of ordinary skill in this art to perform methods in accordance with principles described herein. It is to be understood that examples described are for illustration purposes only, and are not limiting as to the scope of the invention.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

1. A test strip, wherein the test strip comprises information and at least one color encoded field of a shape, a size and a position, wherein the information is encoded in the at least one color encoded field on the test strip.

2. The test strip of claim 1, wherein the at least one color encoded field comprises information for a test type, wherein the test strip is applicable to the test type.

3. (canceled)

4. The test strip of claim 1, wherein the at least one color encoded field comprises information for an instrumentation, wherein the test strip is applicable to the instrumentation.

5. The test strip of claim 1, wherein the at least one color encoded field comprises at least one piece of information selected from calibration information, manufacturer, manufacturing lot identification information, expiration date, an intended method of use, and an intended user.

6. The test strip of claim 1, wherein the at least one color encoded field is illuminated by a reflective illumination source or a transmissive illumination source to generate a light signal, wherein the light signal is processed to reproduce the information.

7-8. (canceled)

9. The test strip of claim 1, wherein the information is independent of at least one parameter of the color encoded field selected from the shape, the size and the position.

10-11. (canceled)

12. The test strip of claim 1, comprising at least a first color encoded field of a first shape, a first size and a first position, and a second color encoded field of a second shape, a second size and a second position.

13. The test strip of claim 12, wherein the first shape of the first color encoded field is different from the second shape of the second color encoded field.

14. The test strip of claim 12, wherein the information is independent of at least one difference selected from the first shape relative to the second shape, the first size relative to the second size, and the first position relative to the second position.

15. The test strip of claim 12, wherein the first size of the first color encoded field is different from the second size of the second color encoded field.

16-17. (canceled)

18. A method of transferring information from a test strip comprising:
providing a test strip, wherein the information is encoded in at least one color encoded field on the test strip;
illuminating the at least one color encoded field with an illumination source; and
generating a light signal.

19. The method of claim 18, wherein the test strip comprises at least two color encoded fields.

20. The method of claim 19, wherein the illuminating the at least two color encoded fields is in series which generates a sequence of light signals.

21. The method of claim 19, wherein the illuminating the at least two color encoded fields is simultaneous.

22. The method of claim 18, wherein the illumination source comprises a reflective illumination source or a transmissive illumination source.

23-61. (canceled)

62. A batch of test strips, wherein each of the test strips comprises information and at least one color encoded field, wherein the information is encoded in the at least one color encoded field on each of the test strip.

63. The batch of test strips of claim 62, wherein at least one test strip of the batch comprises more information than the rest of the batch, wherein each of the rest of the batch comprise the same information.

64. The batch of test strips of claim 62, further comprises an extra information carrying entity, wherein the extra information carrying entity comprises information and at least one information carrying field, wherein the information is encoded in the at least one information carrying field.

65. The batch of test strips of claim 64, wherein the information carrying field comprises a color encoded field.

66. The batch of test strips of claim 64, therein the extra information carrying entity is a container for the batch.

67. The batch of test strips of claim 64, wherein the information encoded on the extra information carrying entity is more than the information encoded on each of the test strips, wherein the information encoded on each of the test strips is the same.
